(19) United States
(12) Patent Application Publication
(10) Pub. No.: US 2009/0245567 A1
(43) Pub. Date: Oct. 1, 2009

(54) TWISTABLE RING SPEAKER CONTROL

(75) Inventors: Jules Egyud, Middltown, NY (US); Michael Cornett, Hazleton, PA (US); James Albert, Honesdale, PA (US); Steve Schlangen, Milford, PA (US)

Correspondence Address: PLANTRONICS, INC.;IP Department/Legal, 345 ENCINAL STREET, P.O. BOX 635, SANTA CRUZ, CA, 95060-0635, US

(73) Assignee: Altec Lansing Technologies, Inc., Milford, PA (US)

(21) Appl. No.: 12/059,088

(22) Filed: Mar. 31, 2008

(51) Int. Cl. H04R 1/02

(52) U.S. Cl. 381/395

(57) ABSTRACT

A twisting ring control for a compact speaker is rotatably mounted on a speaker encircling the speaker baffle. When the ring is rotated in one direction, the ring causes the speaker to be switched off, and when the ring is rotated in the opposite direction, the ring causes the speaker to be switched on. A volume control can be integrated into the same mechanism, and arranged such that, after the speaker is switched on, when the ring is rotated in one direction the volume is increased and when the ring is rotated in the opposite direction the volume is decreased.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to speakers and speaker systems and more particularly, to controls for controlling the operation of speakers and speaker systems.

### BACKGROUND OF THE INVENTION

Compact speakers and speaker systems provide a number of advantages to the owners of such systems. For example, compact speakers may be used to produce ultra portable audio systems. The small size and light weight of the speakers allows the construction of a small, light weight audio system. Compact speakers are also useful in scenarios where space is limited, for example, desktop speakers for a personal computer system.

However, small speakers often have insufficient surface area for important controls, such as on/off switches or volume controls. Even if there is sufficient space on the unit, placing controls on the unit may aesthetically undesirable. Previous solutions have involved hiding conventional controls behind access panels or using reduced size components. Such solutions may be completely unworkable in the case of very small speakers, and invariably increase manufacturing costs.

### OBJECTS AND SUMMARY OF THE INVENTION

It is, therefore, an object of the invention to provide an improved speaker control which overcomes one or more limitations of the prior art.

It is an object of the invention to provide a method of placing controls, such as on/off and/or volume or other controls, on compact speakers where such controls can be easily accessed and used.

It is a further object of the invention to provide a method of placing controls, such as on/off, volume, or other controls, on compact speakers in a manner that is unobtrusive and aesthetically pleasing.

It is a yet another object of the invention to reduce the manufacturing cost for placing controls on compact speakers by eliminating, inter alia, the need to hide one or more controls behind panels that open and close.

In one embodiment, the invention provides a twisting ring control for a compact speaker. The ring is rotatably mounted on the speaker encircling the speaker baffle. When the ring is rotated in one direction, the ring causes the speaker to be switched off, and when the ring is rotated in the opposite direction, the ring causes the speaker to be switched on.

In another embodiment, the invention provides a compact speaker with a twisting ring control, including a speaker housing, a speaker baffle, and a ring rotatably mounted on the speaker housing encircling the speaker baffle. When the ring is rotated in one direction, the ring causes the speaker to be switched off, and when the ring is rotated in the opposite direction, the ring causes the speaker to be switched on.

In yet another embodiment, the invention is a compact speaker with a twisting ring control. The speaker has a housing, with an approximately circular opening with an assembly locking rib on an edge of the circular opening. The speaker has a baffle mounted on or within the circular opening of the housing. The speaker baffle has a receding locking notch and a projecting interference notch. The locking notch engages the assembly locking rib to lock the speaker baffle in a fixed position. The speaker has a ring rotatably mounted on the speaker housing and encircling the speaker baffle. The ring has a receding on-position notch, and a receding off-position notch. When the ring is rotated in one direction such that the off-position notch engages the interference notch, the speaker is switched off. When the ring is rotated in the other direction such that the on-position notch engages the interference notch, the speaker is switched on.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a perspective view of an embodiment of the invention as seen from the top of the device.

FIG. 2 is a close-in perspective view of a portion of an edge of an embodiment of the invention showing the invention in the “on” position.

FIG. 3 is a close-in perspective view of a portion of an edge of an embodiment of the invention showing the invention in the “off” position.

### DETAILED DESCRIPTION OF THE PREFERRED EMBODIMENT

Reference will now be made in detail to the preferred embodiments of the present invention, examples of which are illustrated in the accompanying drawings.

The invention provides an apparatus and method that uses a speaker grill surround ring to provide on/off and/or volume or other controls in products such as ultra portable speakers where conventional controls are undesirable or are aesthetically unacceptable.

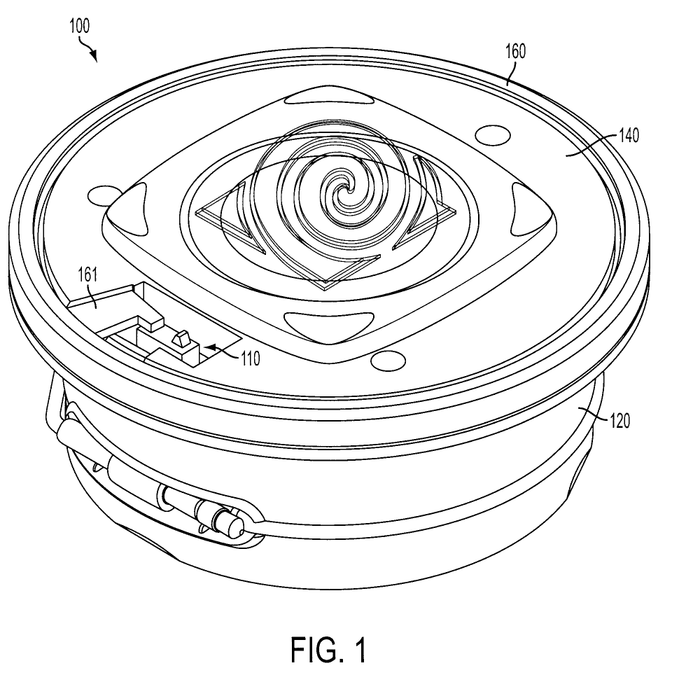

Referring first to FIG. 1, one embodiment, comprises a speaker 100 with a housing 120 a speaker baffle 140 and a twistable grill 160. The grill 160, is molded, with a separate edge ring that engages with and acts upon other parts of the speaker assembly. For example, the embodiment illustrated in FIG. 1, illustrates an implementation of an on/off switch implemented using a twistable edge ring 160 mounted on the speaker housing 120 which can be maintained in “on” and “off” positions. In the “on” position, a molded protrusion of the twistable ring 161 depresses the actuator of a momentary contact switch 110 within the speaker 100. The twistable ring 160 provides tactile snap “on” and “off” feedback to the user during operation.

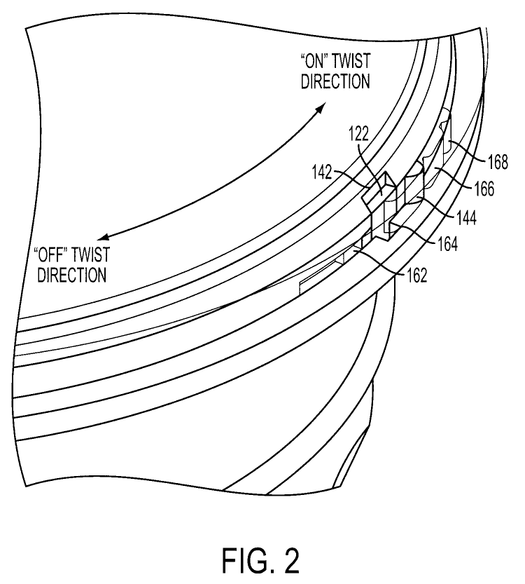

FIG. 2 shows a more detailed view of the locking mechanism of a twistable ring 160 engaged in the “on” position. The twistable ring 160 is rotatably mounted on the speaker housing 120 and surrounds the edge of the speaker baffle 140. The speaker housing has an assembly locking rib 122. As shown in FIG. 2, the assembly locking rib 122 is engaged with the travel limit stop of the twistable ring 162. The speaker baffle 140 is seated on the housing 120 and has a receding locking notch 142 that engages with the assembly locking rib 122 of the speaker housing 140 and locks the baffle in a fixed position on the speaker housing. The speaker baffle 140 also has an outward projecting interference notch 144 that movably engages with notches in the twistable ring 160.

The twistable ring 160 has an projecting travel limit stop 162 a receding on-position notch 164 a receding travel clearance notch 166 and a receding off-position notch 168. As shown, the interference notch 144 is engaged in the on-position notch of the twist ring. In the “on” position, the assembly locking rib 142 is engaged with the travel limit stop 122 of the speaker housing 120 and the interference notch 144 of the speaker baffle 140 projects into the on position notch 164 of the twisting ring 160. The travel limit stop 122 of the housing 120 prevents the twisting ring 160 from being turned further clockwise.

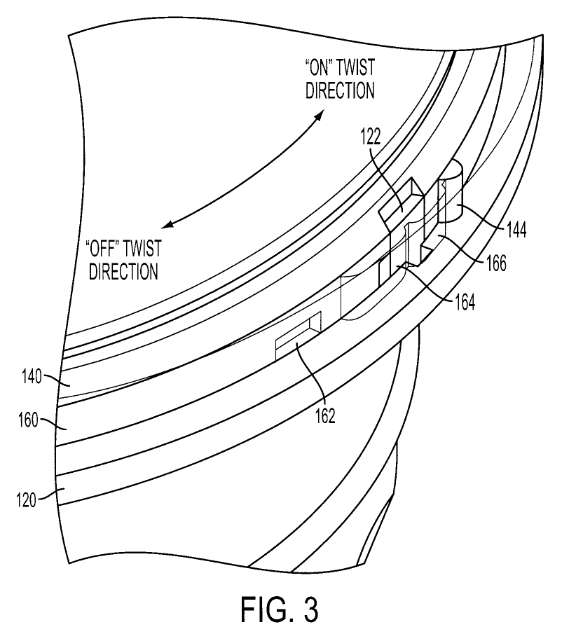

Referring next to FIG. 3. to turn the twisting ring 160 from the “on” position to the “off” position the twisting ring is rotated counterclockwise with respect to the speaker housing 120. The interference notch 144 of the speaker baffle moves out of the on-position notch 164 of the twisting ring 160 and traverses the travel clearance notch 166. When the interference notch 144 reaches the end of the travel clearance notch 166 of the twisting ring 160 there is a slight increase in resistance to turning and if the resistance is overcome the interference notch 144 snaps into place in the off-position notch 168. At this point the twisting ring 160 may be set back to the “on” position by rotating the ring clockwise until the assembly locking rib 122 is engaged with the travel limit stop 162 of the twist ring (as shown in FIG. 2).

While the invention has been particularly shown and described with reference to preferred embodiments thereof, it will be understood by those skilled in the art that various changes in form and details may be made therein without departing from the spirit and scope of the invention.

For example, in other embodiments, the twisting ring may be permitted free travel between the “on” and “off” positions, and incorporate a self molded geared section mated with a pinion mounted on a shaft actuated component or components to control volume or other functions. Furthermore, while the invention is well suited to use in compact speaker systems, it could also be used with full-sized speaker systems.

We claim:

1. A twisting ring control for a compact speaker, comprising:
a ring rotatably mounted on a speaker such that it encircles a baffle of the speaker; and,
a switch mechanism arranged such that when the ring is rotated in one direction, the ring causes the speaker to be switched off, and when it is rotated in the opposite direction, the ring causes the speaker to be switched on.

2. The apparatus of claim 1, wherein the ring is a component of a decorative grill that is mounted over the baffle of a speaker.

3. The apparatus of claim 1, wherein the switch is further arranged such that, after the speaker is switched on, rotating the ring in one direction causes the volume of the speaker to increase and rotating the ring in the other direction causes the volume of the speaker to decrease.

4. A compact speaker with a twisting ring control, comprising:
a speaker housing;
a speaker baffle mounted within the housing;
a ring rotatably mounted on the speaker housing encircling the speaker baffle;
a switch arranged such that when the ring is rotated in one direction, the ring causes the speaker to be switched off, and when the ring is rotated in the opposite direction, the ring causes the speaker to be switched on.

5. The apparatus of claim 4, wherein the ring is a component of a decorative grill that is mounted over the baffle of a speaker.

6. The apparatus of claim 4, wherein the switch is further arranged such that, after the speaker is switched on, rotating the ring in one direction causes the volume of the speaker to increase and rotating the ring in the other direction causes the volume of the speaker to decrease.

7. A compact speaker with a twisting ring control, comprising:
a speaker housing, the speaker housing having a generally circular opening with an assembly locking rib on an edge thereof;
a speaker baffle mounted on or within the circular opening of the housing, the speaker baffle having a receding locking notch and a projecting interference notch, the locking notch being arranged to engage the assembly locking rib to lock the speaker baffle in a fixed position with respect to the speaker housing;
a ring rotatably mounted on the speaker housing and encircling the speaker baffle, the ring having a receding on-position notch and a receding off-position notch,
a switch mechanism arranged such that rotating the ring in one direction causes the off-position notch to engage the interference notch, thereby switching the speaker off, and rotating the ring in the opposite direction causes the on-position notch to engage the interference notch, thereby switching the speaker on.

8. The apparatus of claim 1 wherein the ring is a component of a decorative grill that is mounted over the baffle of a speaker.
